(19) United States
(12) Patent Application Publication
(10) Pub. No.: US 2009/0327550 A1
(43) Pub. Date: Dec. 31, 2009

(54) EMBEDDED SYSTEM AND HARDWARE SETTING METHOD

(75) Inventor: Ding LI, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SILICON MOTION, INC., Hsinchu County (TW)

(21) Appl. No.: 12/208,558

(22) Filed: Sep. 11, 2008

(30) Foreign Application Priority Data
Jun. 27, 2008 (TW) 97124200

(51) Int. Cl. G06F 13/40

(52) U.S. Cl. 710/110

(57) ABSTRACT

An embedded system is provided, comprising a non-volatile memory, at least one slave unit and a master controller. The non-volatile memory comprises at least one hardware setting value and at least one identification number. All of the non-volatile memory, slave unit and the master controller are coupled to a bus. The master controller broadcasts an identification number through the bus to identify the non-volatile memory. Then, the master controller retrieves the slave identification numbers and the hardware setting values through the bus from the non-volatile memory.

### CROSS REFERENCE TO RELATED APPLICATIONS

This application claims priority of Taiwanese Patent Application Serial No. 097124200, filed on Jun. 27, 2008, the entirety of which is incorporated by reference herein.

### BACKGROUND OF THE INVENTION

1. Field of the Invention

The invention relates to an embedded system, and in particular relates to a hardware setting method.

2. Description of the Related Art

An embedded system is a particular type of computer system and is different from a personal computer system. The embedded system usually operates for one special application. Since the embedded system usually operates for one application, designers can optimize the embedded system and easily reduce the size thereof for lower costs.

The core of the embedded system is composed of one or more than one processor or micro controller for particular type of application. The software of the embedded system is usually invariant and called firmware.

### BRIEF SUMMARY OF THE INVENTION

A detailed description is given in the following embodiments with reference to the accompanying drawings.

An embodiment of an embedded system is provided. The embedded system comprises a non-volatile memory, at least one slave unit and a master controller. The non-volatile memory stories at least one hardware setting value and at least one slave identification number (slave ID) and is coupled to a bus. The slave unit is coupled to the bus. The master controller broadcasts an identification number to identify the non-volatile memory and then through the bus retrieves the slave identification number and the hardware setting value from the non-volatile memory.

An embodiment of a hardware setting method is provided. The method comprises broadcasting an identification number (ID), receiving an acknowledge signal (ACK) corresponding to the identification number, identifying the acknowledge signal, setting up at least one hardware setting value corresponding to the identification number, and retrieving at least one of the slave identification numbers.

Another embodiment of a hardware setting method is provided. The method comprises retrieving at least one slave identification number from a non-volatile memory, broadcasting one of the slave identification numbers of the non-volatile memory, determining whether to receive a first acknowledge signal (ACK) from a slave unit or not, identifying the first acknowledge signal when receiving the first acknowledge signal, setting up at least one hardware setting value corresponding to the slave identification number, and returning to the step of broadcasting one of the slave identification numbers when other slave identification numbers are available.

### BRIEF DESCRIPTION OF THE DRAWINGS

The invention can be more fully understood by reading the subsequent detailed description and examples with references made to the accompanying drawings, wherein:

FIG. 1 shows an embedded system according to an embodiment of the invention; and

FIG. 2 shows a flow chart of a hardware setting method according to an embodiment of the invention;

FIG. 3 shows a signal timing diagram of the embedded system according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

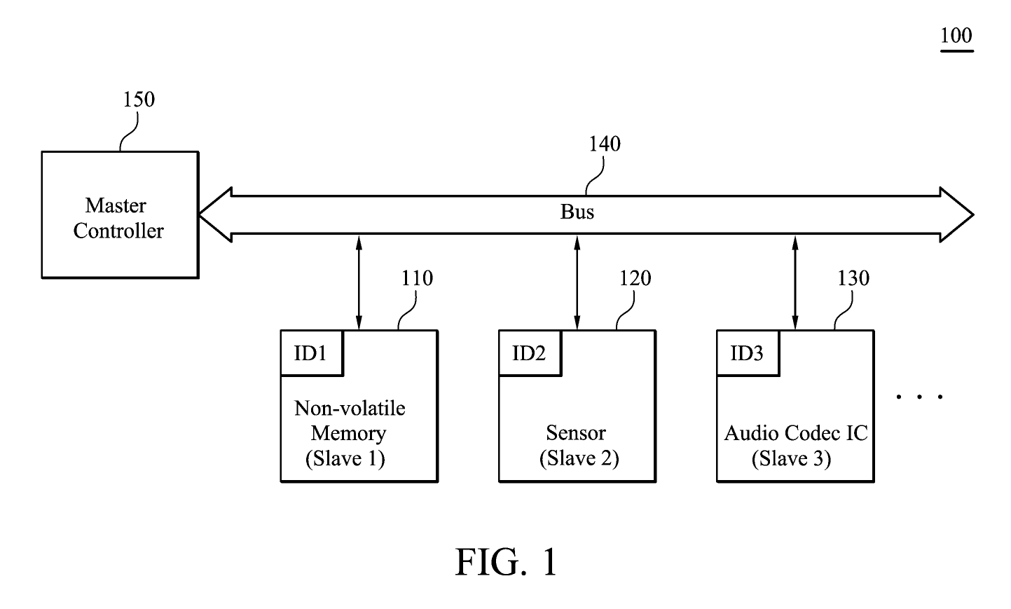

FIG. 1 shows an embedded system 100 according to an embodiment of the invention. The embedded system comprises a master controller 150, a bus 140, a non-volatile memory 110 and at least one slave unit. According to an embodiment of the invention, which is not limiting thereto, the slave units are a sensor 120 and an audio codec IC 130, as shown in FIG. 1. The slave unit can be a web camera or a DVD player. The non-volatile memory 110 can be an erasable programmable read-only memory (EPROM) or an electrically-erasable programmable read-only memory (EEPROM). The bus 140 is coupled to the sensor 120, the audio codec IC 130, the memory 110 and the master controller 150. Thus, the master controller 150 can control the memory 110, the sensor 120 and the audio codec IC through the bus 140.

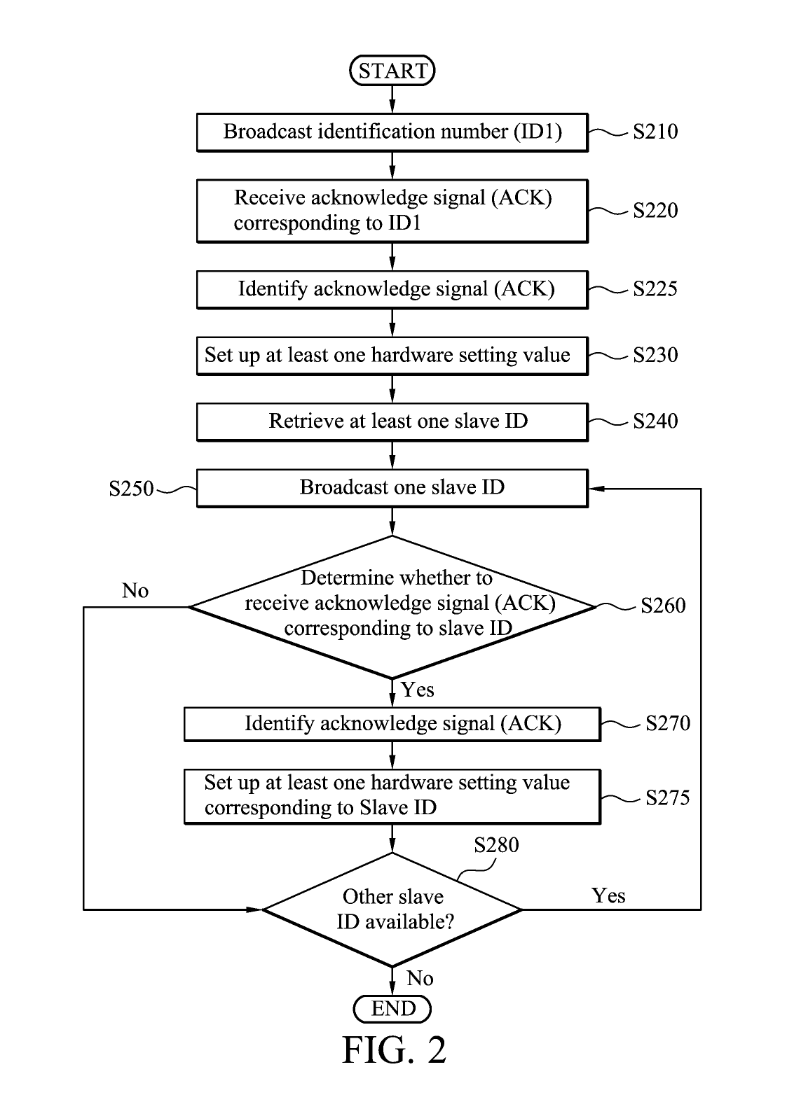

FIG. 2 shows a flow chart of a hardware setting method according to an embodiment of the invention. The master controller 150 stores at least one identification number and at least one hardware setting value. First, the master controller 150 broadcasts an identification number one ID1 corresponding to the memory 110. After the memory 110 receives the identification number one ID1 (step S210), the memory 110 generates an acknowledge signal ACK. After the master controller 150 receives the acknowledge signal ACK corresponding to the identification number one ID1 (step S220), the master controller 150 identifies the acknowledge signal as corresponding to a type of memory (step S225). Then, the master controller 150 sets up at least one hardware setting value for communicating with the memory 110 (step S230).

The memory 110 stores at least one hardware setting value and at least one slave identification number (Slave ID). The master controller 150 can retrieve the at least one hardware setting value and the at least one slave identification number (Slave ID) from the memory 110. According to an embodiment of the invention, the memory 110 stores hardware setting values and slave identification numbers corresponding to the sensor 120 and the audio codec IC 130. Thus, the master controller 150 can retrieve the slave identification numbers and the hardware setting values corresponding to the sensor 120 and the audio codec IC 130 (step S240). The master controller 150 first broadcasts the slave identification number corresponding to the sensor 120 (step S250). After the sensor 120 receives the slave identification number, the sensor generates an acknowledge signal ACK. The master controller 150 determines whether to receive the acknowledge signal from the sensor 120 or not within a predetermined time period (step S260). If the master controller 150 receives the acknowledge signal from the sensor 120, the master controller 150 identifies the acknowledge signal to determine the corresponding type of sensor (step S270). Then, the master controller 150 sets up at least one hardware setting value for communicating with the sensor 120 (step S275). Then, the master controller 150 determines whether the other slave identification numbers have not been broadcasted (are available) (step S280). If there are other slave identification numbers which have not been broadcasted, the process returns to step S250. According to an embodiment of the invention, if the master controller 150 has not broadcasted the slave identification number corresponding to the audio codec IC 130, the master controller 150 broadcasts the slave identification number corresponding to the audio codec IC 130 (step S250). Subsequent processes are similar to the previous described embodiment and thus, are not described again.

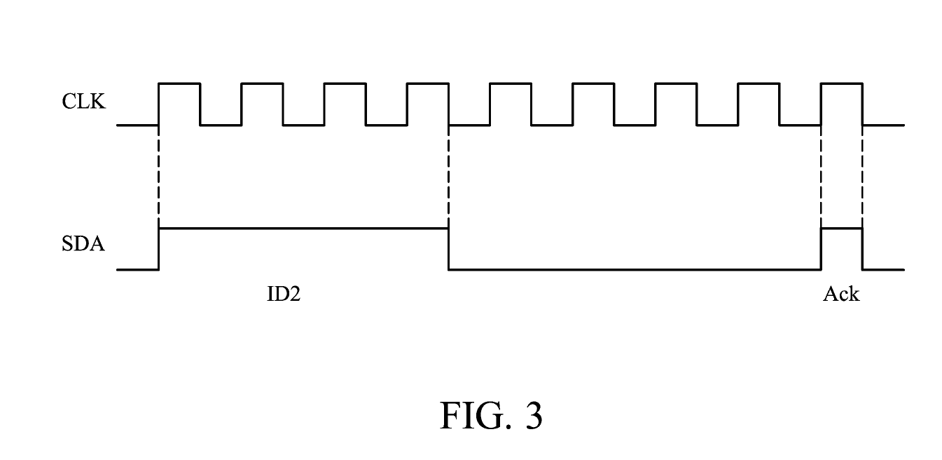

FIG. 3 shows a signal timing diagram of the embedded system according to an embodiment of the invention. The master controller 150 broadcasts an identification number ID2 carried by a data signal SDA through the bus 140. Because the sensor 120 corresponds to the identification number ID2, after the sensor 120 receives the corresponding identification number ID2, the sensor 120 can generate an acknowledge signal ACK within a predetermined time period. In an embodiment of the invention, the acknowledge signal ACK is generated at the ninth clock of a clock signal CLK, as shown in FIG. 3. The non-volatile memory 110 and the audio codec IC 130 respectively correspond to the identification numbers ID1 and ID3, as shown in FIG. 1. With regard to the non-volatile memory 110 and the audio codec IC 130, the operations are similar to the previous described embodiment and thus, are not described again.

Engineers can store different identification numbers and hardware setting values into a programmable non-volatile memory. After the master controller identifies the programmable non-volatile memory, the master controller can retrieve other identification numbers and hardware setting values from the programmable non-volatile memory for communication with and control of other devices or units. Therefore, the master controller 150 usually is designed to broadcast ID1 corresponding to the non-volatile memory 110 at the first beginning or initialization of the embedded system 100. In other word, the master controller 150 usually broadcasts ID1 corresponding to the non-volatile memory 110 before broadcasts ID2 corresponding to the sensor 120 or ID3 corresponding to the audio codec IC 130.

While the invention has been described by way of example and in terms of preferred embodiment, it is to be understood that the invention is not limited to thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An embedded system, comprising
a non-volatile memory storing at least one hardware setting value and at least one slave identification number (slave ID), and coupled to a bus;
at least one slave unit coupled to the bus; and
a master controller broadcasting an identification number to identify the non-volatile memory and then through the bus getting the slave identification number and the hardware setting value from the non-volatile memory.

2. The embedded system as claimed in claim 1, wherein the slave unit is a web camera, a sensor, a DVD player, or an audio codec IC.

3. The embedded system as claimed in claim 1, wherein the master controller broadcasts the slave identification number through the bus to identify the slave unit.

4. The embedded system as claimed in claim 1, wherein the master controller sets up hardware setting values for communicating with the slave unit.

5. The embedded system as claimed in claim 1, wherein after the master controller identifies the non-volatile memory, the master controller sets up one memory hardware setting value for communicating with the non-volatile memory.

6. The embedded system as claimed in claim 1, wherein the non-volatile memory is an erasable programmable read-only memory or electrically-erasable programmable read-only memory.

7. The embedded system as claimed in claim 1, wherein after the slave unit or the non-volatile memory receives the slave identification number or the identification number from the master controller, the slave unit or the non-volatile memory outputs an acknowledge signal (ACK) and then the master controller receives the acknowledge signal to identify the slave unit or the non-volatile memory.

8. A hardware setting method, comprising:
broadcasting an identification number (ID);
receiving an acknowledge signal (ACK) corresponding to the identification number;
identifying the acknowledge signal;
setting up at least one hardware setting value corresponding to the identification number; and
retrieving at least one slave identification number for further configuration.

9. The hardware setting method as claimed in claim 8, further comprising:
broadcasting one of the slave identification numbers;
determining whether to receive a first acknowledge signal (ACK) corresponding to the slave identification number or not;
identifying the first acknowledge signal when receiving the first acknowledge signal;
setting up at least one hardware setting value corresponding to the slave identification number; and
returning to the step of broadcasting one of the slave identification numbers when the other slave identification numbers are available.

10. The hardware setting method as claimed in claim 9, wherein a master controller broadcasts the identification number (ID) through a bus to identify a non-volatile memory and then through the bus retrieves the slave identification number and the hardware setting value from the non-volatile memory to control a slave unit.

11. The hardware setting method as claimed in claim 10, wherein the slave unit is a web camera, a sensor, a DVD player, or an audio codec IC.

12. The hardware setting method as claimed in claim 10, wherein the master controller broadcasts the slave identification numbers through the bus to identify the slave unit.

13. The hardware setting method as claimed in claim 10, wherein the master controller sets up the hardware setting values for communicating with the slave unit.

14. The hardware setting method as claimed in claim 10, wherein after the master controller identifies the non-volatile memory, the master controller sets up one memory hardware setting value for communicating with the non-volatile memory.

15. The hardware setting method as claimed in claim 10, wherein the non-volatile memory is an erasable programmable read-only memory or electrically-erasable programmable read-only memory.

16. A hardware setting method, comprising:
retrieving at least one slave identification number from a non-volatile memory;
broadcasting one of the slave identification numbers of the non-volatile memory;
determining whether to receive a first acknowledge signal (ACK) from a slave unit or not;
identifying the first acknowledge signal when receiving the first acknowledge signal;
setting up at least one hardware setting value corresponding to the slave identification number; and
returning to the step of broadcasting one of the slave identification numbers when the other slave identification numbers are available.

17. The hardware setting method as claimed in claim 16, wherein a master controller broadcasts an identification number to identify the non-volatile memory and then through a bus retrieving the slave identification number and the hardware setting value from the non-volatile memory for controlling the slave unit.

18. The hardware setting method as claimed in claim 16, wherein the slave unit is a web camera, a sensor, a DVD player, or an audio codec IC.

19. The hardware setting method as claimed in claim 10, wherein the non-volatile memory is an erasable programmable read-only memory or electrically-erasable programmable read-only memory.

20. The hardware setting method as claimed in claim 17, wherein after the master controller identifies the non-volatile memory, the master controller sets up one memory hardware setting value for communicating with the non-volatile memory.
